(19) United States
(12) Patent Application Publication
(10) Pub. No.: US 2025/0312720 A1
(43) Pub. Date: Oct. 9, 2025

(54) Dust Collecting Device And Method Of Use

(71) Applicant: Mack Glover, Lansing, IL (US)

(72) Inventor: Mack Glover, Lansing, IL (US)

(21) Appl. No.: 18/629,493

(22) Filed: Apr. 8, 2024

(51) Int. Cl. B01D 46/00; B01D 46/10; B01D 46/42

(52) U.S. Cl. CPC B01D 46/0045; B01D 46/0047; B01D 46/10; B01D 46/4245; B01D 2273/30

(57) ABSTRACT

A dust collecting device for maintaining a dust free surface includes a housing, which defines an interior space and which can be positioned on a surface, such as a table, which is subject to deposition of dust. A fan and a battery are attached to the housing and are positioned in the interior space, with the battery being operationally engaged to the fan. A filter is selectively positionable in the interior space so that the filter is positioned in-line with the fan between a plurality of intake holes and a plurality of exhaust holes that are positioned in the housing. The fan draws air through the intake holes, forces the air through the filter to remove particulates from the air, and expels the filtered air though the exhaust holes so that accumulation of dust upon the surface is reduced.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to filters and more particularly pertains to a new filter for maintaining a dust free surface, such as a tabletop, desktop, or the like, which may require frequent dusting.

### (2) Description of Related Art Including Information Disclosed Under 37 CFR 1.97 and 1.98

The prior art relates to filters to maintain dust free surfaces, which typically rely on suctioning to vacuum up dust but which do not utilize air filtration to prevent deposition of dust.

### BRIEF SUMMARY OF THE INVENTION

An embodiment of the disclosure meets the needs presented above by generally comprising a housing, which defines an interior space and which is configured to be positioned on a surface, such as a table, which is subject to deposition of dust. A fan and a battery are attached to the housing and are positioned in the interior space, with the battery being operationally engaged to the fan. A filter is selectively positionable in the interior space so that the filter is positioned in-line with the fan between a plurality of intake holes and a plurality of exhaust holes that are positioned in the housing. The fan is configured to draw air through the intake holes, to force the air through the filter to remove particulates from the air, and to expel the filtered air though the exhaust holes so that accumulation of dust upon the surface is reduced.

Another embodiment of the disclosure includes a method of reducing accumulation of dust on a surface subject to deposition of dust. The method comprises providing a dust collecting device, according to the disclosure above. Steps of the method include positioning a filter in the interior space of the housing, positioning the housing on the surface subject to deposition of dust, drawing of air through the intake holes, forcing the air through the filter to remove particulates from the air, and expelling the filtered air though the exhaust holes so that accumulation of dust upon the surface is reduced.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a dust collecting device according to an embodiment of the disclosure.

FIG. 2 is a side view of an embodiment of the disclosure.

FIG. 3 is a cross-sectional view of an embodiment of the disclosure.

FIG. 4 is a bottom isometric perspective view of an embodiment of the disclosure.

FIG. 5 is an exploded view of an embodiment of the disclosure.

FIG. 6 is an in-use view of an embodiment of the disclosure.

FIG. 7 is a flow diagram for a method utilizing an embodiment of the disclosure.

### DETAILED DESCRIPTION OF THE INVENTION

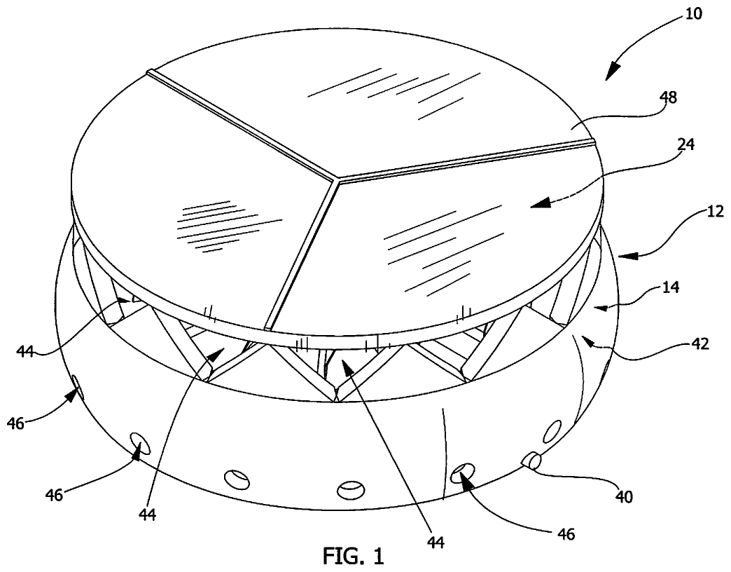

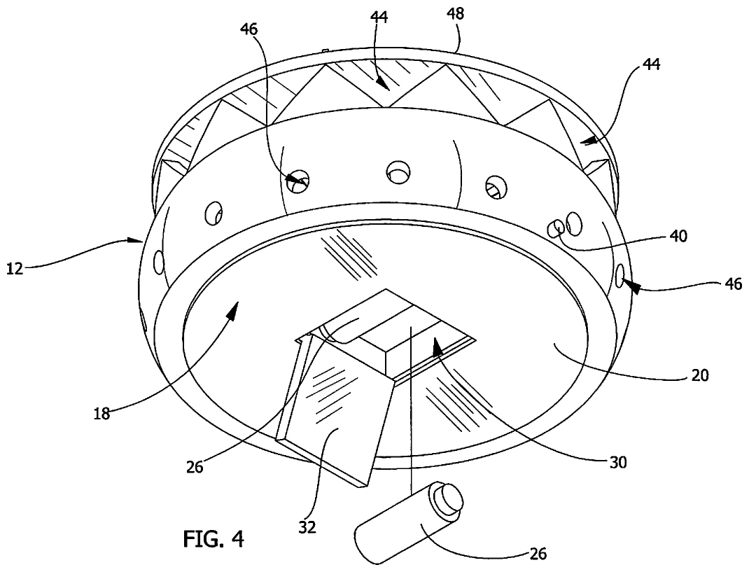

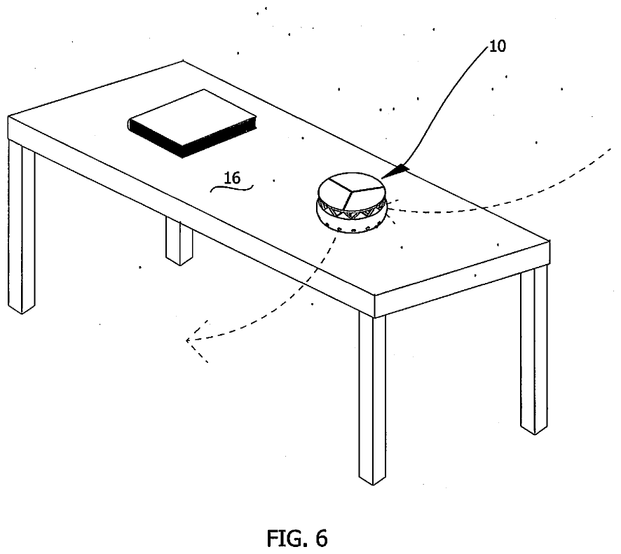

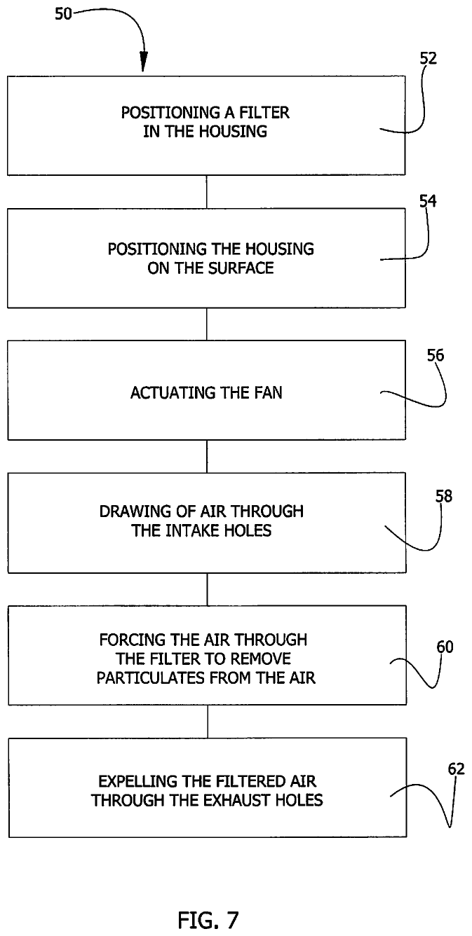

With reference now to the drawings, and in particular to FIGS. 1 through 7 thereof, a new filter embodying the principles and concepts of an embodiment of the disclosure and generally designated by the reference number 10 will be described.

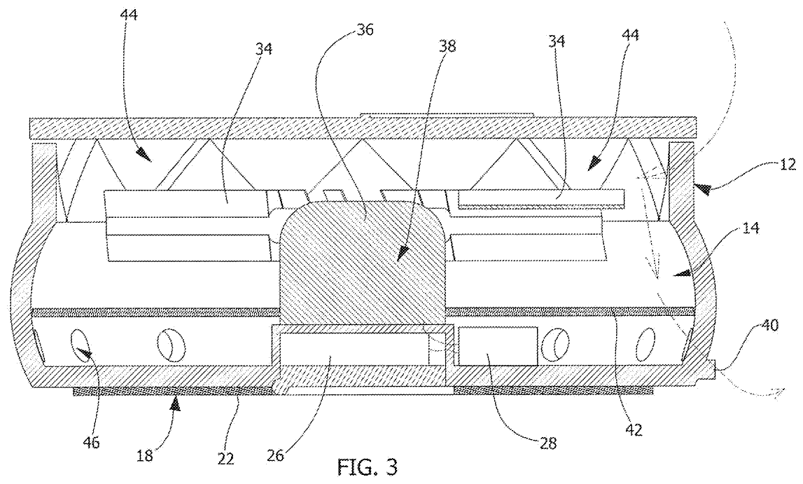

As best illustrated in FIGS. 1 through 7, the dust collecting device 10 generally comprises dust collecting device 10 a housing 12, which defines an interior space 14 and which is configured to be positioned on a surface 16, such as a table, that is subject to deposition of dust. The housing 12 may be substantially disc shaped, as is shown in FIGS. 1-6, or alternatively shaped, such as, but not limited to, cuboid shaped, frustum shaped, or the like. A fastener 18 may be attached to a bottom 20 of the housing 12 and be configured to removably attach the housing 12 to the surface 16 to maintain the housing 12 in position. The fastener 18 may comprise pressure sensitive adhesive 22, as is shown in FIG. 3, or other fastening means, such as, but not limited to, hook and loop fasteners, magnets, or the like.

A fan 24, a battery 26, and a microprocessor 28 are attached to the housing 12 and are positioned in the interior space 14, with the microprocessor 28 being operationally engaged to the fan 24 and the battery 26. The battery 26 is accessible through a cutout 30 that is positioned in the housing 12, allowing for the battery 26 to be replaced as needed. A panel 32 is hingedly attached to the housing 12 and is configured to selectively attach to the housing 12 to close the cutout 30. The present invention also anticipates the battery 26 being rechargeable.

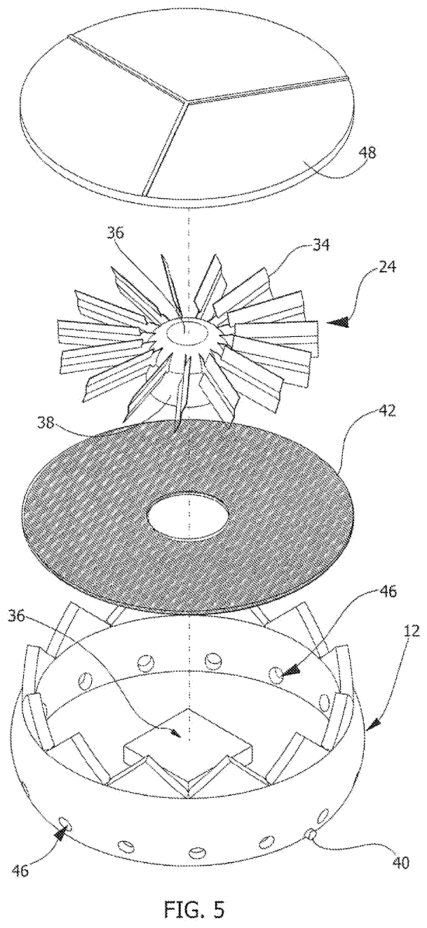

The fan 24 may be of any conventional configuration and may, as is shown in FIG. 5, comprises a blade assembly 34, which is attached to or which is selectively attachable to a shaft 36 of a motor 38. A switch 40 is attached to the housing 12, is operationally engaged to the microprocessor 28, and is configured to be selectively switched to power on the fan 24. Also anticipated, but not shown, is a controller attached to the housing 12 and operationally engaged to the microprocessor 28. The controller would enable the user to set a speed of the fan 24, such as low, medium, and high.

A filter 42 is selectively positionable in the interior space 14 so that the filter 42 is positioned in-line with the fan 24 between a plurality of intake holes 44 and a plurality of exhaust holes 46 that are positioned in the housing 12. As is shown in FIG. 5, a top 48 of the housing 12 is detachable to allow for insertion of the filter 42. The filter 42 is anticipated to comprise standard filtering materials, such as foam, pleated paper, spun fiberglass, or the like. The filter 42 can be readily removed for cleaning or replacement.

The fan 24 is configured to draw air through the intake holes 44, to force the air through the filter 42 to remove particulates from the air, and to expel the filtered air though the exhaust holes 46 so that accumulation of dust upon the surface 16 is reduced. FIG. 3 shows the filter 42 being positioned between the fan 24 and the exhaust holes 46 so that the air is pushed through the filter 42. The present invention also anticipates the filter 42 being positioned between the fan 24 and the intake holes 44 so that the air is pulled through the filter 42.

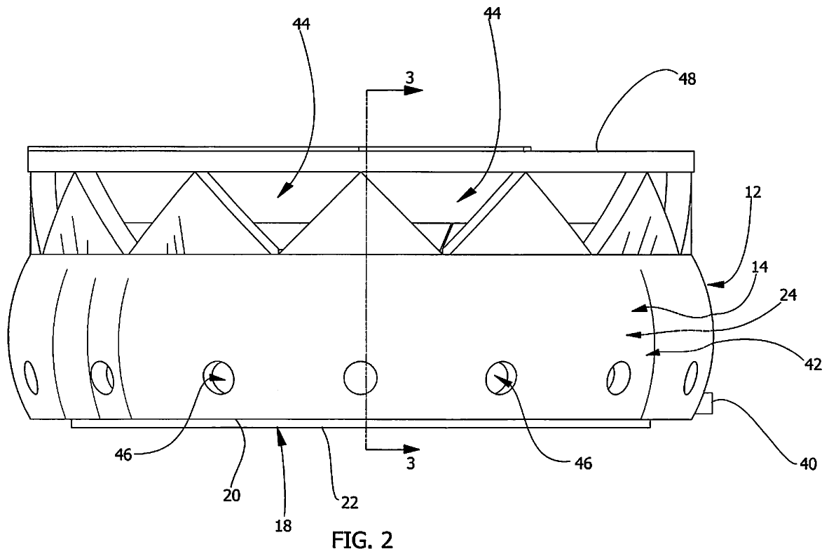

As is shown in FIG. 2, the intake holes 44 and the exhaust holes 46 are positioned proximate to the top 48 and proximate to the bottom 20 of the housing 12, respectively. Although reversal of the positioning of the intake holes 44 and the exhaust holes 46 also is anticipated, having the exhaust holes 46 positioned proximate to the bottom 20 of the housing 12 allows the exhausted air to dislodge dust from the surface 16. The plurality of intake holes 44 and the plurality of exhaust holes 46 may extend circumferentially around the housing 12 to promote efficient intake of dust and distribution of filtered air, respectively. The intake holes 44 or the exhaust holes 46 also could be positioned in the top 48 of the housing 12.

In use, the dust collecting device 10 enables a method of reducing accumulation of dust on a surface subject to deposition of dust 50. The method 50 comprises providing a dust collecting device 10, according to the specification above. A first step 52 of the method 50 is positioning a filter 42 in the interior space 14 of the housing 12. A second step 54 of the method 50 is positioning the housing 12 on the surface 16 subject to deposition of dust. A third step 56 of the method 50 is actuating the fan 24. A fourth step 58 of the method 50 is drawing of air through the intake holes 44. A fifth step 60 of the method 50 is forcing the air through the filter 42 to remove particulates from the air. A sixth step 62 of the method 50 is expelling the filtered air though the exhaust holes 46 so that accumulation of dust upon the surface 16 is reduced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dust collecting device comprising:
a housing defining an interior space and configured to be positioned on a surface subject to deposition of dust;
a fan attached to the housing and positioned in the interior space;
a filter selectively positionable in the interior space, such that the filter is positioned in-line with the fan between a plurality of intake holes and a plurality of exhaust holes positioned in the housing; and
a battery attached to the housing and positioned in the interior space, the battery being operationally engaged to the fan, wherein the fan is configured to draw air through the plurality of intake holes, to force the air through the filter to remove particulates from the air, and to expel the filtered air though the plurality of exhaust holes, such that accumulation of dust upon the surface is reduced.

2. The dust collecting device of claim 1, wherein the housing is substantially disc shaped.

3. The dust collecting device of claim 1, further including a fastener attached to a bottom of the housing and being configured for removably attaching the housing to the surface.

4. The dust collecting device of claim 3, wherein the fastener comprises pressure sensitive adhesive.

5. The dust collecting device of claim 1, wherein the fan comprises:
a motor; and
a blade assembly attached to or selectively attachable to a shaft of the motor;

6. The dust collecting device of claim 1, wherein:
the plurality of intake holes is positioned proximate to a top of the housing; and
the plurality of exhaust holes is positioned proximate to a bottom of the housing.

7. The dust collecting device of claim 1, wherein:
the plurality of intake holes extends circumferentially around the housing; and
the plurality of exhaust holes extends circumferentially around the housing.

8. The dust collecting device of claim 1, further including:
the battery being accessible through a cutout positioned in the housing; and
a panel hingedly attached to the housing and being configured to selectively attach to the housing to close the cutout.

9. The dust collecting device of claim 1, further including:
a switch attached to the housing; and
a microprocessor attached to the housing and positioned in the interior space, the microprocessor being operationally engaged to the fan, the battery, and the switch, such that the switch is configured to be selectively switched to power on the fan.

10. A dust collecting device comprising:
a housing defining an interior space and configured to be positioned on a surface subject to deposition of dust, the housing being substantially disc shaped;
a fastener attached to a bottom of the housing and being configured for removably attaching the housing to the surface, the fastener comprising pressure sensitive adhesive;
a fan attached to the housing and positioned in the interior space, the fan comprising:
a motor; and
a blade assembly attached to or selectively attachable to a shaft of the motor;
a filter selectively positionable in the interior space, such that the filter is positioned in-line with the fan between a plurality of intake holes and a plurality of exhaust holes positioned in the housing, the plurality of intake holes being positioned proximate to a top of the housing, the plurality of exhaust holes being positioned proximate to the bottom of the housing, the plurality of intake holes extending circumferentially around the housing, the plurality of exhaust holes extending circumferentially around the housing;
a battery attached to the housing and positioned in the interior space, the battery being operationally engaged to the fan, wherein the fan is configured to draw air through the plurality of intake holes, to force the air through the filter to remove particulates from the air, and to expel the filtered air though the plurality of exhaust holes, such that accumulation of dust upon the surface is reduced, the battery being accessible through a cutout positioned in the housing;
a panel hingedly attached to the housing and being configured to selectively attach to the housing to close the cutout;
a switch attached to the housing; and
a microprocessor attached to the housing and positioned in the interior space, the microprocessor being operationally engaged to the fan, the battery, and the switch, such that the switch is configured to be selectively switched to power on the fan.

11. A method of reducing accumulation of dust on a surface subject to deposition of dust, the method comprising providing a dust collecting device according to claim 1, and:
positioning a filter in the interior space of the housing;
positioning the housing on the surface subject to deposition of dust;
actuating the fan;
drawing of air through the plurality of intake holes;
forcing the air through the filter to remove particulates from the air; and
expelling the filtered air though the plurality of exhaust holes, such that accumulation of dust upon the surface is reduced.
